(19) United States
(12) Patent Application Publication
(10) Pub. No.: US 2007/0008721 A1
(43) Pub. Date: Jan. 11, 2007

(54) Light string having alternating current light-emitting diodes

(75) Inventors: Chi-Tsung Peng, Hsinchu City (TW); Kuo-Hsiang Wen, Hsinchu City (TW)

Correspondence Address: BIRCH STEWART KOLASCH & BIRCH, PO BOX 747, FALLS CHURCH, VA, 22040-0747, US

(73) Assignee: BAYCOM OPTO-ELECTRONICS TECHNOLOGY CO., LTD.

(21) Appl. No.: 11/176,649

(22) Filed: Jul. 8, 2005

(51) Int. Cl. B60Q 1/26

(52) U.S. Cl. 362/227

(57) ABSTRACT

A light string has a pair of wires and a plurality of alternating current light-emitting diodes (AC LEDs). The pair of wires is arranged to provide an AC voltage. Each of the AC LEDs is electrically connected in parallel between the pair of wires. The light string can decrease the manufacturing cost, reduce the space occupied by additional circuitry, and lower heat produced thereby for enhancing the operational safety of long-term use.

### BACKGROUND

1. Field of Invention

The present invention relates to circuit arrangements for electric light sources. More particularly, the present invention relates to a light string having alternating current light-emitting diodes.

2. Description of Related Art

Although traditional incandescent sources are cheap, they have disadvantages of low efficiency, high power consumption, short lifespan and fragility. Fluorescent sources can save power, but are still fragile and generate environmental concerns due to their containing-mercury wastes. Light-emitting is diodes (LEDs), which are durable, long-lived and power-saving, and do not contain hazardous wastes like mercury, have become an ideal new generation light source.

For example, LEDs have several favorable physical properties including ruggedness, cool operation, and ability to operate under wide temperature variations. Moreover, a typical LED lifespan is at least 100,000 hours, and may consume an order of magnitude less power than incandescent bulbs of equivalent light output. In addition, LEDs have many different types and wide applications, and have therefore become important light tools for daily use.

A light string used for decorative or lighting purposes are one application of LEDs. For example, U.S. Pat. No. 5,495,147 entitled “LED LIGHT STRING SYSTEM” to Lanzisera and U.S. Pat. No. 4,984,999 entitled “STRING OF LIGHTS SPECIFICATION” to Leake describe different forms of LED-based light strings. In both Lanzisera and Leake, exemplary light strings are described using a power conversion scheme, such as a step-down transformer or a rectifier, to provide electrical power to LEDs.

FIG. 1A is a schematic view of an example disclosed by U.S. Pat. No. 5,495,147, and FIG. 1B is a schematic view of another example disclosed by U.S. Pat. No. 5,495,147. A direct current (DC) input, such as a direct current of 10 volts, is converted into a direct current of a low voltage by a step-down transformer 102 as illustrated in FIG. 1A. Alternatively, an alternating current (AC) input, such as a household power of 110 VAC, is converted into a direct current of a low voltage by a rectifier 112 as illustrated in FIG. 1B. Afterwards, the direct current of low voltage is provided to a light string 104 having a plurality of LEDs.

However, these additional circuits, such as the step-down transformer 102 or the rectifier 112, increase the cost of the light string, affect the appearance of the light string due to occupying space, and decrease safety of long-term use because of heat generated by the additional circuits. The additional circuits have their own lifespan limitations; for example, the rectifier has a lifespan of 10000 hours, and thus decreases the whole lifespan of the application in which the LEDs have a longer lifespan. Furthermore, in order to match the DC power with polarity, the positive and negative pins of the LEDs, which are connected to the light string, must be installed according to a specific polarity rule. It increases the manufacturing complexity of the light string, or otherwise other foolproof mechanisms have to be used to ensure the pins can be correctly installed following the specific polarity rule.

### SUMMARY

It is therefore an aspect of the present invention to provide a light string, which can be directly powered by the AC voltage, and thus omit additional circuits, prolong the lifespan and decrease the manufacturing cost of the light string.

According to one preferred embodiment of the present invention, the light string comprises a pair of wires and a plurality of alternating current light-emitting diodes (AC LEDs). The pair of wires provides an alternating current voltage. Each of the AC LEDs is electrically connected in parallel between the pair of wires.

It is another aspect of the present invention to provide a light string, which is easy to manufacture and is cheap, and has simple circuits and a high safety of long-term use.

According to another preferred embodiment of the present invention, the light string comprises a main pair of wires and a plurality of secondary light strings. The main pair of wires provides an AC voltage. Each of the secondary light strings comprises a secondary pair of wires and a plurality of AC LEDs. Each wire of the secondary pair of wires is connected to one of the main pair of wires, respectively. Each of the AC LEDs is electrically connected in parallel between the secondary pair of wires.

In conclusion, the light string of the present invention can directly use the AC voltage, and omit the required additional circuits of the conventional light string, such as a step-down transformer or a rectifier. Therefore, the manufacturing cost of the light string is decreased, and the space taken up by the additional circuits is reduced. Moreover, the light string consumes less power because it does not suffer a power loss caused by AC to DC conversion, and therefore the heat is also reduced to enhance the safety of the long-term use.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A is a schematic view of an exemplary example disclosed by U.S. Pat. No. 5,495,147;

FIG. 1B is a schematic view of another exemplary example disclosed by U.S. Pat. No. 5,495,147;

FIG. 2 is a schematic view of one preferred embodiment of the present invention; and

FIG. 3 is a schematic view of another preferred embodiment of the present invention.

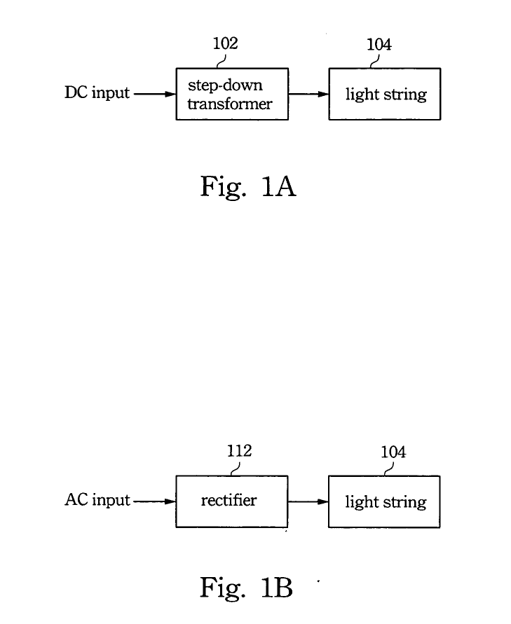

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The light string of the present invention uses AC LEDs as its light source, and associates with corresponding parallel wirings in order to omit the conventional additional circuits. Therefore, the manufacturing cost of the light string is decreased, the space occupied by the additional circuits is reduced, and the heat is reduced to enhance the safety of long-term use. Moreover, the AC LEDs need not be configured according to a specific polarity rule as are conventional DC LEDs. Thus, the manufacturing complexity of the light string is decreased, and other foolproof mechanisms are not needed, which ensure correct installation of the pins.

Conventional LEDs generally adapt to a DC voltage. If an AC voltage is used, a rectifier is required for the LEDs to convert the AC voltage to a DC voltage. Alternating current light-emitting diodes (AC LEDs) can be powered directly by AC voltage. Based on the characteristic of AC voltage, the electrical current periodically changing its flowing direction, a circuit for making the current flow in a single direction is provided inside the AC LED.

For example, by the design of packaging on a single base, the circuit can be connected to several light-emitting elements in straight lines. Microchip processes can be applied to a single power chip to make it possible to be operated by a high AC voltage and a low current. Moreover, because the single power chip is bi-directionally turned on, a punchthrough caused by electrostatic discharge (ESD) can be avoided. The AC LEDs can use an AC voltage with a frequency greater than 50 Hertz and voltage greater than 100 volts. By operating under a DC voltage, the output power of an AC LED is 50% greater than that of a DC LED of the same chip size.

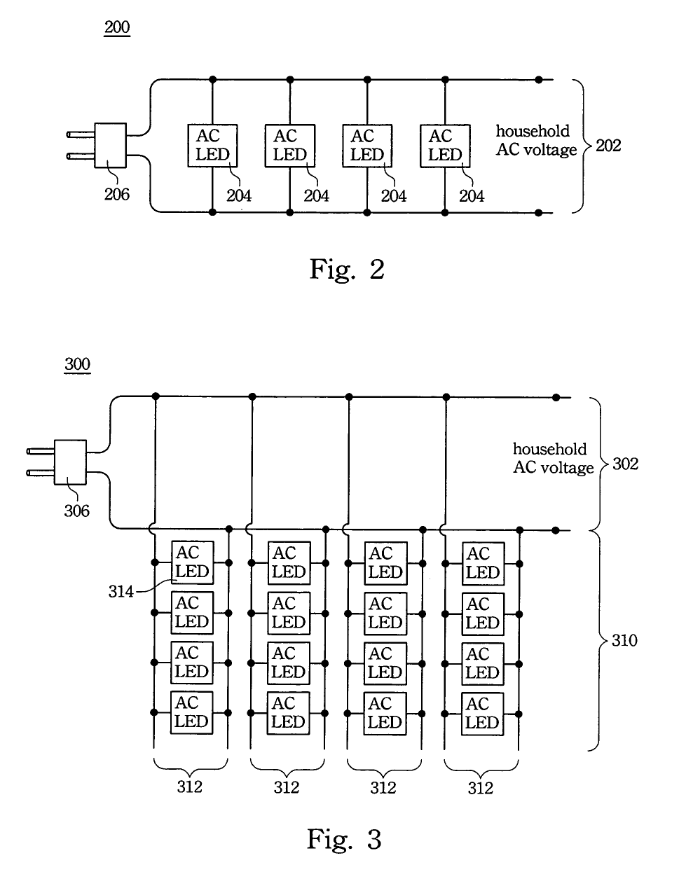

FIG. 2 is a schematic view of one preferred embodiment of the present invention. A light string 200 comprises a pair of wires 202 and a plurality of AC LEDs 204. The pair of wires 202 provides an AC voltage. Each of the AC LEDs 204 is electrically connected in parallel between the pair of wires 202. That is, each of the AC LEDs 204 is equivalently coupled to the AC voltage, and thus is directly powered by AC power rather than DC power degraded or rectified from AC power by other additional circuits. As mentioned above, the AC LEDs 204 are bi-directionally turned on, and therefore their position and negative pins can be configured on the pair of wires 202 without obeying the specific polarity rule.

Moreover, the light string 200 can further have a power plug 206, which is electrically connected to the pair of wires 202. The power plug 206 is plugged into a wall-plug power socket to access the AC voltage, such as a wall-plug AC voltage, a household AC voltage or a voltage provided by other AC power source. The AC voltage cycles a forward voltage and a reverse voltage continuously, and has different transient voltages at different times. In different countries or regions, the wall-plug AC voltage can be between about 100 volts and 240 volts. Additionally, a frequency of the wall-plug AC voltage, the cycling frequency of the forward voltage and the reverse voltage, is generally greater than 50 hertz, such as between 50 hertz and 60 hertz.

For example, the wall-plug AC voltage in Taiwan and the U.S. is 60 hertz and 110 volts, the wall-plug AC voltage in Eastern Japan is 50 hertz and 100 volts, and the wall-plug AC voltage in the U.K. is 50 hertz and 230 or 240 volts. Of course, the light string 200 preferably uses AC LEDs 204 suitable for the wall-plug AC voltage in the region where the light string 200 is used, in order to obtain a better performance.

In addition, the AC LEDs 204 connected to the light string 200 may have a single color or a plurality of colors. According to embodiments of the present invention, the AC LEDs 204 can be randomly arranged or be arranged in color order along with the pair of wires 202.

FIG. 3 is a schematic view of another preferred embodiment of the present invention. A light string 300 comprises a main pair of wires 302 and a plurality of secondary light strings 310. The main pair of wires 302 provides an AC voltage. Each of the secondary light strings 310 comprises a secondary pair of wires 312 and a plurality of AC LEDs 314. Each wire of each secondary pair of wires 312 is connected to one of the main pair of wires 302, respectively. Each of the AC LEDs 314 is electrically connected in parallel between the secondary pair of wires 312.

That is, each of the AC LEDs 314 is equivalently coupled to the AC voltage, and thus is directly powered by AC power rather than a DC power degraded or rectified from the AC power by other additional circuits. As mentioned above, the AC LEDs 314 are bi-directionally turned on, and therefore their position and negative pins can be configured on the secondary pair of wires 312 without obeying the specific polarity rule.

Moreover, the light string 300 can further have a power plug 306, which is electrically connected to the main pair of wires 302. The power plug 306 is plugged into a wall-plug power socket to access the AC voltage, such as a wall-plug AC voltage, a household AC voltage or a voltage provided by other AC power source. In different countries or regions, the wall-plug AC voltage can be between about 100 volts and 240 volts. Additionally, a frequency of the wall-plug AC voltage is generally greater than 50 hertz, such as between 50 hertz and 60 hertz. Of course, the light string 300 preferably uses AC LEDs 314 suitable for the wall-plug AC voltage in the region where the light string 300 is used, in order to obtain a better performance.

In addition, the AC LEDs 314 connected to the light string 300 may have a single color or have a plurality of colors. According to embodiments of the present invention, the AC LEDs 314 can be randomly arranged or be arranged in color order. More precisely, if the AC LEDs 314 of the same secondary light IS string 310 have the same color, the secondary light strings 310 can be randomly arranged, or be arranged in color order along with the main pair of wires 302. If the AC LEDs 314 of each of the secondary light strings 310 have a plurality of colors, and the AC LEDs 314 of the same secondary light strings 310 can be arranged in color order along with the secondary pair of wires 312, or can be randomly arranged.

It is noted that the secondary pair of wires 312 can connect the same number or different numbers of AC LEDs. Persons skilled in the art can selecte the required numbers, connecting positions and color arrangements of AC LEDs 314 according to different designs and circuitries. Furthermore, the embodiments as illustrated in FIGS. 2 and 3 can also be employed in a mixture. In other words, other AC LEDs also can be electrically connected in parallel between the main pair of wires 302 in FIG. 3, and the invention is not limited by the embodiment illustrated above.

AC LEDs have a longer lifespan than those of the incandescent sources, and consumes less power so as to generate less heat and enhance safety. AC LEDs can be installed without obeying a specific polarity rule as the conventional DC LEDs, thus decreasing the manufacturing complexity of the light string, and also omitting other foolproof mechanisms for ensuring the pins are correctly installed.

In conclusion, the light string of the present invention can directly use the AC voltage, and omit the required additional circuits, such as a step-down transformer or a rectifier, of the conventional light string. Therefore, the manufacturing cost of the light string is decreased, and the space taken up by the additional circuits is reduced. Moreover, the light string consumes less power because is does not suffer the power loss caused by AC to DC conversion, and therefore heat produced thereby is also reduced to enhance the safety of the long-term use.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light string, comprising:
a pair of wires for providing a alternating current (AC) voltage; and
a plurality of alternating current light-emitting diodes (AC LEDs), wherein each of the AC LEDs is electrically connected in parallel between the pair of wires.

2. The light string of claim 1, wherein the light string further comprises a power plug electrically connected to the pair of wires, for plugging into a wall-plug power socket to provide the AC voltage.

3. The light string of claim 1, wherein a voltage of the AC voltage is between about 100 volts and 240 volts, and a frequency of the AC voltage is greater than about 50 hertz.

4. The light string of claim 1, wherein the AC LEDs have a single color.

5. The light string of claim 1, wherein the AC LEDs have a plurality of colors.

6. The light string of claim 5, wherein the AC LEDs are arranged in color order along with the pair of wires.

7. The light string of claim 5, wherein the AC LEDs are not arranged in color order.

8. The light string of claim 1, wherein the AC LEDs are adapted to a wall-plug AC voltage.

9. A light string, comprising:
a main pair of wires for providing an AC voltage; and
a plurality of secondary light strings, each of the secondary light strings comprising:
a secondary pair of wires, wherein each wire of the secondary pair of wires is connected to one wire of the main pair of wires, respectively; and
a plurality of AC LEDs, wherein each of the AC LEDs is electrically connected in parallel between the secondary pair of wires.

10. The light string of claim 9, wherein the light string further comprises a power plug electrically connected to the pair of wires, for coupling to a wall-plug power socket to provide the AC voltage.

11. The light string of claim 9, wherein a voltage of the AC voltage is between about 100 volts and 240 volts, and a frequency of the AC voltage is greater than about 50 hertz.

12. The light string of claim 9, wherein the AC LEDs have a single color.

13. The light string of claim 9, wherein the AC LEDs have a plurality of colors.

14. The light string of claim 13, wherein the AC LEDs of one secondary light string are of a single color.

15. The light string of claim 14, wherein the secondary light strings are arranged in color order along with the main pair of wires.

16. The light string of claim 14, wherein the secondary light strings are not arranged in color order.

17. The light string of claim 13, wherein the AC LEDs of each of the secondary light strings have a plurality of colors, and the AC LEDs of one secondary light string are arranged in color order along with the secondary pair of wires.

18. The light string of claim 13, wherein the AC LEDs of each of the secondary light strings have a plurality of colors, and the AC LEDs of one secondary light string are not arranged in color order.

19. The light string of claim 9, wherein the AC LEDs are adapted to a wall-plug AC voltage.
